(19) United States
(12) Patent Application Publication
(10) Pub. No.: US 2026/0073737 A1
(43) Pub. Date: Mar. 12, 2026

(54) LATENT LAYER CONVERSION OF SIGNALS BETWEEN SOFTWARE VERSIONS

(71) Applicant: Ford Global Technologies, LLC, Dearborn, MI (US)

(72) Inventors: David Michael Herman, West Bloomfield, MI (US); Anuj Pal, St. Paul, MN (US)

(21) Appl. No.: 18/829,706

(22) Filed: Sep. 10, 2024

(51) Int. Cl. G07C 5/00; G06N 20/00

(52) U.S. Cl. CPC G07C 5/008; G06N 20/00

(57) ABSTRACT

Using universal signals for determining vehicle metrics is provided. Based on vehicle signals received from one or more vehicles, a latent space model including an encoder and a decoder is trained, the encoder generating universal signals as a latent representation of the vehicle signals, the decoder generating reconstructed vehicle signals from the universal signals. The encoder is sent to the one or more vehicles. Universal signals are received from the one or more vehicles, the universal signals being generated through use of the encoder on the vehicle signals. The universal signals are applied to an analysis model to determine metrics with respect to the operation of the one or more vehicles from the latent representation.

### TECHNICAL FIELD

Aspects of the disclosure generally relate to use of a latent layer on-vehicle for converting software version-specific signals to a common signal representation.

### BACKGROUND

Connected vehicles may send data to a cloud system. UBI is a type of vehicle insurance whereby the premium cost is dependent on the driving behavior of a driver. A UBI device may be connected to a vehicle network via a connector such as an on-board diagnostic II (OBD-II) port to collect vehicle operating data and send the data to a remote server for analysis. In other examples, a telematics control unit (TCU) of the vehicle may collect the vehicle operating data and send the data to the remote server for analysis.

An autoencoder is a type of artificial neural network used in unsupervised learning for data compression and feature extraction. An autoencoder includes of two main parts: an encoder that compresses the input data into a latent space representation, and a decoder that reconstructs the original data from this compressed form.

### SUMMARY

In one or more illustrative examples, a method of using universal signals for determining vehicle metrics, includes training, based on vehicle signals received from one or more vehicles, a latent space model including an encoder and a decoder, the encoder generating universal signals as a latent representation of the vehicle signals, the decoder generating reconstructed vehicle signals from the universal signals; sending the encoder to the one or more vehicles; receiving universal signals from the one or more vehicles, the universal signals being generated through use of the encoder on the vehicle signals; and applying the universal signals to an analysis model to determine metrics with respect to the operation of the one or more vehicles from the latent representation.

In one or more illustrative examples, the vehicle signals received from one or more vehicles are filtered according to user filter policies specifying which of the vehicle signals are to be included in the universal signals.

In one or more illustrative examples, the method further includes varying parameters and/or conditions that affect the vehicle signals, such as changes in driving style, weather conditions, road types, or vehicle load; performing resimulating using a generative model to generate new instances of the vehicle signals, simulating vehicle behavior under the varying parameters and/or conditions; and adding the resimulated vehicle signals to the vehicle signals as an expanded dataset for training the latent space model.

In one or more illustrative examples, the method further includes performing co-training of the analysis model and the latent space model using a loss function that accounts for loss in the latent space model and also loss in the analysis model, thereby ensuring fidelity of the universal signals with respect to the analysis model.

In one or more illustrative examples, the method further includes defining the universal signals as a vector of a first version of the vehicle signals in combination with additional future version elements set to a default value, wherein the vehicle signals received from one or more vehicles are of a second version of the vehicle signals, and the training ensures fidelity of the first version of the vehicle signals and the second version of the vehicle signals through the latent space model.

In one or more illustrative examples, the training includes training a plurality of latent space models on subsets of the vehicle signals, each of the plurality of latent space models including an encoder and decoder pair; and combining the outputs of a plurality of encoders of the encoders of the encoder and decoder pairs to generate the universal signals.

In one or more illustrative examples, the analysis model determines metrics with respect to vehicle maintenance.

In one or more illustrative examples, the analysis model determines metrics with respect to usage-based insurance.

In one or more illustrative examples, the method further includes detecting a change in distribution of the vehicle signals and/or presence of outlier events in the vehicle signals; retraining the latent space model to generate an updated encoder; and sending the updated encoder to the one or more vehicles.

In one or more illustrative examples, a system for using universal signals for determining vehicle metrics, includes one or more computing devices including non-transitory storage and a processor, configured to train, based on vehicle signals received from one or more vehicles, a latent space model including an encoder and a decoder, the encoder generating universal signals as a latent representation of the vehicle signals, the decoder generating reconstructed vehicle signals from the universal signals; send the encoder to the one or more vehicles; receive universal signals from the one or more vehicles, the universal signals being generated through use of the encoder on the vehicle signals; and apply the universal signals to an analysis model to determine metrics with respect to the operation of the one or more vehicles from the latent representation.

In one or more illustrative examples, the vehicle signals received from one or more vehicles are filtered according to user filter policies specifying which of the vehicle signals are to be included in the universal signals.

In one or more illustrative examples, the one or more computing devices are further configured to vary parameters and/or conditions that affect the vehicle signals, such as changes in driving style, weather conditions, road types, or vehicle load; perform resimulating using a generative model to generate new instances of the vehicle signals, simulating vehicle behavior under the varying parameters and/or conditions; and add the resimulated vehicle signals to the vehicle signals as an expanded dataset for training the latent space model.

In one or more illustrative examples, the one or more computing devices are further configured to perform co-training of the analysis model and the latent space model using a loss function that accounts for loss in the latent space model and also loss in the analysis model, thereby ensuring fidelity of the universal signals with respect to the analysis model.

In one or more illustrative examples, the one or more computing devices are further configured to define the universal signals as a vector of a first version of the vehicle signals in combination with additional future version elements set to a default value, wherein the vehicle signals received from one or more vehicles are of a second version of the vehicle signals, and the training ensures fidelity of the first version of the vehicle signals and the second version of the vehicle signals through the latent space model.

In one or more illustrative examples, the one or more computing devices are further configured to train a plurality of latent space models on subsets of the vehicle signals, each of the plurality of latent space models including an encoder and decoder pair; and combine the outputs of a plurality of encoders of the encoders of the encoder and decoder pairs to generate the universal signals.

In one or more illustrative examples, the analysis model determines metrics with respect to vehicle maintenance.

In one or more illustrative examples, the analysis model determines metrics with respect to usage-based insurance.

In one or more illustrative examples, a non-transitory computer-readable medium includes instructions that, when executed by one or more processors of one or more computing devices, cause the one or more computing devices to perform operations including to train, based on vehicle signals received from one or more vehicles, a latent space model including an encoder and a decoder, the encoder generating universal signals as a latent representation of the vehicle signals, the decoder generating reconstructed vehicle signals from the universal signals; send the encoder to the one or more vehicles; receive universal signals from the one or more vehicles, the universal signals being generated through use of the encoder on the vehicle signals; and apply the universal signals to an analysis model to determine metrics with respect to the operation of the one or more vehicles from the latent representation.

In one or more illustrative examples, the non-transitory computer-readable further includes instructions that, when executed by the one or more computing devices, cause the one or more computing devices to perform operations including to perform co-training of the analysis model and the latent space model using a loss function that accounts for loss in the latent space model and also loss in the analysis model, thereby ensuring fidelity of the universal signals with respect to the analysis model.

In one or more illustrative examples, the non-transitory computer-readable further includes instructions that, when executed by the one or more computing devices, cause the one or more computing devices to perform operations including to: train a plurality of latent space models on subsets of the vehicle signals, each of the plurality of latent space models including an encoder and decoder pair; and combine the outputs of a plurality of encoders of the encoders of the encoder and decoder pairs to generate the universal signals.

### BRIEF DESCRIPTION OF THE DRAWINGS

FIG. 1 illustrates an example system for using a latent layer on-vehicle for converting software version-specific signals to a common signal representation;

FIG. 2 illustrates an example autoencoder architecture for use in the system of FIG. 1;

FIG. 3A illustrates a version A of the signals being as a baseline for the universal signals;

FIG. 3B illustrates a version B of the signals being encoded as the universal signals;

FIG. 3C illustrates the version A of the signals being applied as the universal signals to the decoder of FIG. 3B;

FIG. 4 illustrates an alternate autoencoder architecture in which the signals from separate subsystems of the vehicle are processed separately;

FIG. 5 illustrates an example of co-training of the autoencoder with the analysis model;

FIG. 6 illustrates an example loopwise process for using the universal signals for determining metrics using the analysis models; and

FIG. 7 illustrates an example computing device for using universal signals for determining vehicle metrics.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicle operation models are incorporating more low-level signals, e.g., from driving assist and/or autonomous driving features, to improve the accuracy of the models. However, these low-level signals may differ between software versions, as the underlying algorithms that generate the signals might change. For example, new signals may be added, existing signals may be modified, or signals may be dropped and no longer available. Not only that, but there may be changes to signal naming, interface structures, and underlying hardware.

Collecting signal data for each version may be expensive, and re-training the model for every software update may be problematic. Thus, aspects of the disclosure relate to a method to convert a set of custom vehicle low level signals to a common set of signals for use with the vehicle operation model.

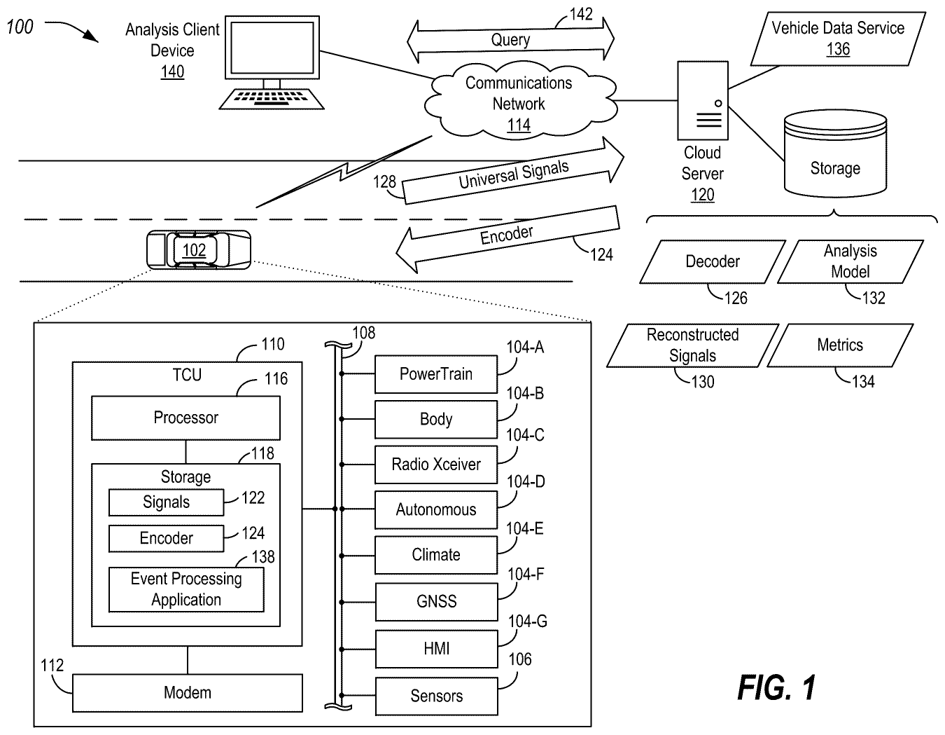

FIG. 1 illustrates an example system 100 for using a latent layer on-vehicle for converting software version-specific signals to a common signal representation. The system 100 includes one or more vehicles 102, where each vehicle 102 includes a plurality of controllers 104 and sensors 106. Each vehicle 102 also includes one or more vehicle buses 108 for communication between the controller 104, sensors 106, and a telematics control unit (TCU) 110. The TCU 110 includes or otherwise has access to a modem 112 configured to facilitate communication over a communication network 114. The TCU 110 may include a processor 116 and a storage 118. The TCU 110 may capture signals 122 and maintain them in the storage 118. The storage 118 may also maintain an event processing application 138 and an encoder 124. The event processing application 138 may use the encoder 124 to encode the signals 122 into universal signals 128 and may send the universal signals 128 to a cloud server 120. The cloud server 120 may also be configured to execute a vehicle data service 136 that uses one or more analysis models 132 to operate on the universal signals 128 to determine various metrics 134. The metrics 134 may also be provided to client devices 140 responsive to client queries 142, in an example, to facilitate quoting insurance rates for the vehicles 102 and/or for scheduling maintenance for the vehicles 102. It should be noted that the system 100 is only an example, and systems 100 with more, fewer, or different components may be used.

The vehicle 102 may be any various types of automobile, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be powered by an engine. As another possibility, the vehicle 102 may be a battery electric vehicle (BEV) powered by one or more electric motors. As a further possibility, the vehicle 102 may be a hybrid electric vehicle (HEV) powered by both an engine and one or more electric motors, such as a series hybrid electric vehicle (SHEV), a parallel hybrid electrical vehicle (PHEV), or a parallel/series hybrid electric vehicle (PSHEV). Alternatively, the vehicle 102 may be an autonomous vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs). It should be noted that while automotive vehicles 102 are being used as examples of traffic participants, other types of traffic participants may additionally or alternately be used, such as bicycles, scooters, and pedestrians.

The vehicle 102 may include a plurality of controllers 104 configured to perform and manage various vehicle 102 functions under the power of the vehicle battery and/or drivetrain. As depicted, the example vehicle controllers 104 are represented as discrete controllers 104 (i.e., controllers 104A through 104G). However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104A may be configured to provide control of engine operating components (e.g., idle control components, fuel delivery components, emissions control components, etc.) and for monitoring status of such engine operating components (e.g., status of engine codes); a body controller 104B may be configured to manage various power control functions such as exterior lighting, interior lighting, keyless entry, remote start, and point of access status verification (e.g., closure status of the hood, doors and/or trunk of the vehicle 102); a radio transceiver controller 104C may be configured to communicate with key fobs, mobile devices, or other local vehicle 102 devices; an autonomous controller 104D may be configured to provide commands to control the powertrain, steering, or other aspects of the vehicle 102; a climate control management controller 104E may be configured to provide control of heating and cooling system components (e.g., compressor clutch, blower fan, temperature sensors, etc.); a global navigation satellite system (GNSS) controller 104F may be configured to provide vehicle location information; and a human-machine interface (HMI) controller 104G may be configured to receive user input via various buttons or other controls, as well as provide vehicle status information to a driver, such as fuel level information, engine operating temperature information, and current location of the vehicle 102.

The controllers 104 of the vehicle 102 may make use of various sensors 106 in order to receive information with respect to the surroundings of the vehicle 102. In an example, these sensors 106 may include one or more of cameras (e.g., advanced driver-assistance system (ADAS) cameras), ultrasonic sensors, radar systems, and/or lidar systems.

One or more vehicle buses 108 may include various methods of communication available between the vehicle controllers 104, as well as between the TCU 110 and the vehicle controllers 104. As some non-limiting examples, the vehicle bus 108 may include one or more of a vehicle controller area network (CAN), an Ethernet network, and a media-oriented system transfer (MOST) network.

The TCU 110 may include network hardware configured to facilitate communication between the vehicle controllers 104 and with other devices of the system 100. For example, the TCU 110 may include or otherwise access a modem 112 configured to facilitate communication over a communication network 114. The TCU 110 may, accordingly, be configured to communicate over various protocols, such as with the communication network 114 over a network protocol (such as Uu). The TCU 110 may, additionally, be configured to communicate over a broadcast peer-to-peer protocol (such as PC5), to facilitate cellular vehicle-to-everything (C-V2X) communications with devices such as other vehicles 102. It should be noted that these protocols are merely examples, and different peer-to-peer and/or cellular technologies may be used.

The TCU 110 may include various types of computing apparatus in support of performance of the functions of the TCU 110 described herein. In an example, the TCU 110 may include one or more processors 116 configured to execute computer instructions, and a storage 118 medium on which the computer-executable instructions and/or data may be maintained. A computer-readable storage medium (also referred to as a processor-readable medium or storage 118) includes any non-transitory (e.g., tangible) medium that participates in providing data (e.g., instructions) that may be read by a computer (e.g., by the processor(s) 116). In general, the processor 116 receives instructions and/or data, e.g., from the storage 118, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, etc.

The TCU 110 may be configured to include one or more interfaces from which information of the vehicle 102 may be sent and received. This information can be sensed, recorded, and sent to one or more cloud servers 120. In an example, similar to the TCU 110, the cloud server 120 may also include one or more processors (not shown) configured to execute computer instructions, and a storage medium (not shown) on which the computer-executable instructions and/or data may be maintained.

The TCU 110 may be configured to facilitate the collection of vehicle signals 122 from the vehicle controllers 104 connected to the one or more vehicle buses 108. These may include, for example, ADAS signals generated by ADAS functions of the vehicle 102. While only a single vehicle bus 108 is illustrated, it should be noted that in many examples, multiple vehicle buses 108 are included, usually with a subset of the controllers 104 connected to each vehicle bus 108. Accordingly, to access a given controller 104, the TCU 110 may be configured to maintain a mapping of which vehicle buses 108 are connected to which controllers 104, and to access the corresponding vehicle bus 108 for a controller 104 when communication with that particular controller 104 is desired.

As used herein, vehicle signals 122 (e.g., ADAS signals and the like) may refer to various binary, multi-state, integer, float, and/or continuous parameters that may be generated or otherwise raised by the vehicle controller 104 and/or sensors 106. The signals 122 may include varying unit types, such as time series data of differing frequency and event streams, and/or differing object types such as float, array, matrices, nested data types, etc. As some non-limiting examples, the vehicle signals 122 may include one or more of: latitude, longitude, time, heading angle, speed, throttle position, brake status, steering angle, headlight status, wiper status, external temperature, turn signal status, ambient temperature or other weather conditions, alertness status, hands-off-wheel status, all-wheel drive (AWD) engaged status, front object detection, side object detection status, rear object detection status, etc.

The signals 122 present on the vehicle 102 may vary based on the software and hardware versions of the controllers 104 and/or sensors 106 of the vehicle 102. Thus, rather than sending the signals 122 as present on the vehicle 102, the TCU 110 and cloud server 120 may collectively use an autoencoder architecture.

An autoencoder is a type of neural network designed to learn efficient, compressed representations of input data in an unsupervised manner. For example, the autoencoder may be trained to capture the most important features of the signals 122 in a way that allows the signals 122 to be accurately reconstructed from a compressed representation. To do so, the autoencoder includes to two main components: the encoder 124 and a decoder 126. It should be noted that this is only an example embodiment, but other embodiments may be possible. As some other possibilities, a variant of an autoencoder may be used, such as a variational, adversarial, denoising, stacked, conditional, and/or multi-modal neural network. In other examples, other architectures may be used, such as a transformer network, statistical machine translation, or even a recurrent neural network (RNN) with an attention mechanism.

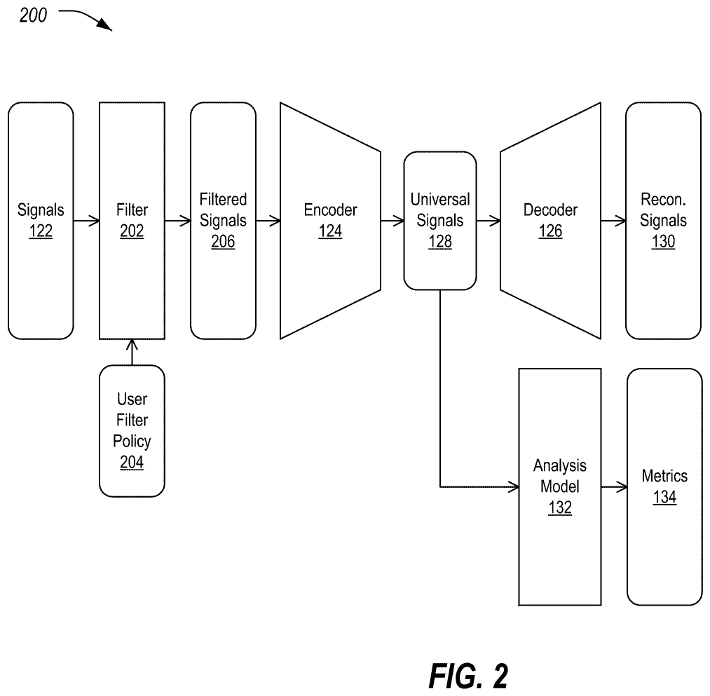

FIG. 2 illustrates an example autoencoder architecture 200 for use in the system 100. As shown in FIG. 2, and with continuing reference to FIG. 1, the signals 122 are received as an input to the autoencoder architecture 200. The signals 122 may be processed by a filter 202 using a user filter policy 204 to generate filtered signals 206, which may then be applied to the encoder 124. The encoder 124 may be installed to the vehicle 102 and may convert a representation of the filtered signals 206 into universal signals 128. The universal signals 128 may be transmitted by the vehicle 102 to the cloud server 120. If desired, the universal signals 128 may be converted into reconstructed signals 130 by a decoder 126 corresponding to the encoder 124. The universal signals 128 may also be processed by one or more analysis models 132 on the cloud server 120 to generate metrics 134.

The filter 202 may be configured to remove information from the signals 122 as desired by the user of the vehicle 102. In an example, one user may opt into allowing all signals 122 of the vehicle 102 to be used by the cloud server 120 for processing. In another example, another user may opt into allowing only a subset of the signals 122 to be used. For instance, one user may prefer to allow the user of signals 122 such as steering wheel input, speed, lane, etc., while another use may prefer to avoid use of some of those signals 122, such as providing speed but not steering wheel input. It should be noted that other the filter 202 may also perform other filtering operations as a signal level filter (e.g. a Kalman filter, a particle filter), and/or produce a sensor fusion output. One or more of these operations may be optional and user configurable as well. These preferences of the user may be stored to the vehicle 102 as a user filter policy 204, which may be applied to the signals 122 by the filter 202 to generate filtered signals 206.

The encoder 124 is a neural network that receives the filtered signals 206 and compresses them into a smaller, lower-dimensional representation, referred to as a latent space. This latent space captures the essential features of the filtered signals 206 while discarding less important information, allowing for a more compact representation. The output of the encoder 124 is referred to herein as the universal signals 128.

The decoder 126 is another neural network that takes the latent representation from the encoder 124 (e.g., the universal signals 128) and attempts to reconstruct the original signals 122 from the universal signals 128. The decoder 126 reverses the encoding process, expanding the compressed latent space back into the original data's dimensions.

A training process may be performed for the autoencoder to minimize difference between the original signals 122 input to the encoder 124 and the reconstructed signals 130 output from the decoder 126. This may be accomplished using a loss function such as mean squared error or another suitable function (such as a domain-specific loss function). Thus, the autoencoder may learn to compress data into a smaller form that can later be reconstructed with minimal loss of information. Moreover, the autoencoder may also perform denoising of the signals 122 to address potentially corrupted data by learning to reconstruct a clean version of the data from its noisy version. A monitoring of a denoising autoencoder loss metric may also serve as a sanity check on the autoencoder translation, either in the training process or potentially on-vehicle.

Referring back to FIG. 1, the analysis model 132 may be any of various machine learning models trained to determine metrics 134 based on the signals 122 (here the universal signals 128). In an example, an analysis model 132 may be configured to infer metrics 134 relates to vehicle 102 based on a training of the analysis model 132 using universal signals 128 from vehicles 102 with known outcomes. In one example, an analysis model 132 may be trained on maintenance data for vehicles 102 based on universal signal 128 data to allow the analysis model 132 to determine metrics 134 with respect to likely maintenance required by the vehicle 102. In another example, an analysis model 132 may be trained on insurance data for vehicles 102 based on universal signal 128 data to allow the analysis model 132 to determine metrics 134 with respect to likely incidents that may occur due to how the vehicle 102 is being driven.

The system 100 may further include one or more client devices 140 configured to access the cloud server 120 over the communication network 114. Using the services of the vehicle data service 136 of the cloud server 124, the one or more client devices 140 may be configured to perform queries 142 for the metrics 134 for various information, e.g., for preparation of insurance quotes for the vehicles 102 and/or for scheduling maintenance of the vehicles 102.

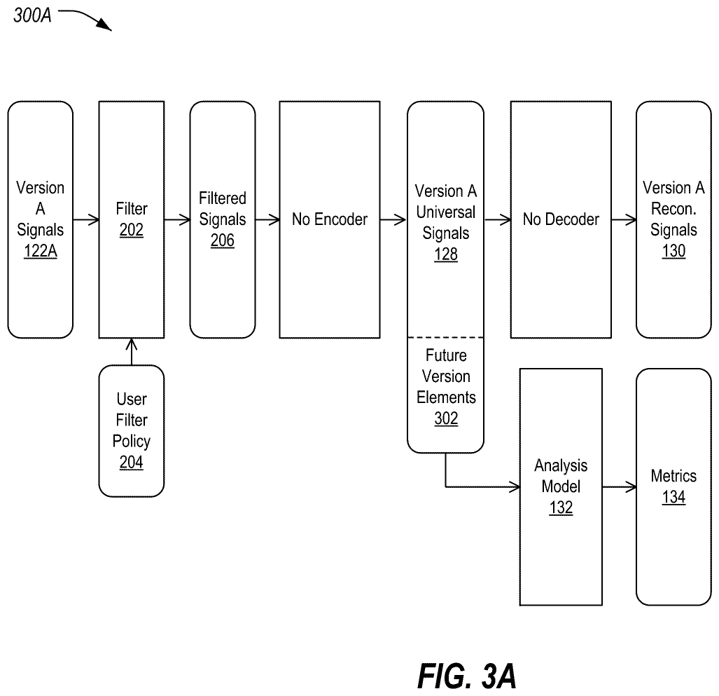

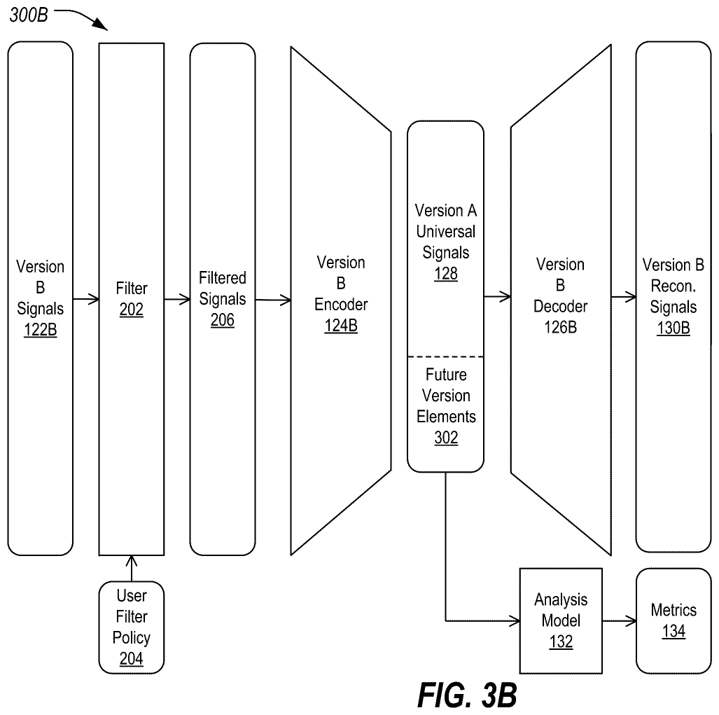

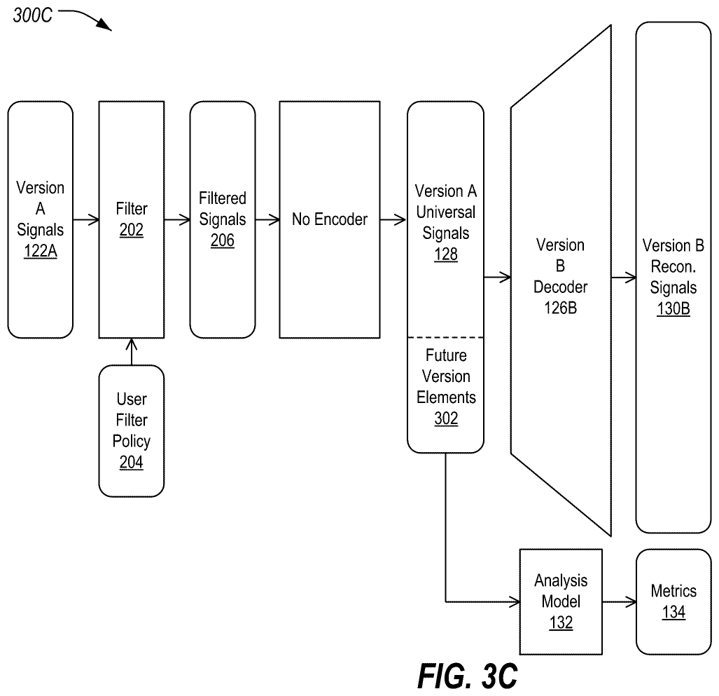

FIGS. 3A and 3B collectively illustrate examples of using one version of signals 122A from a vehicle 102 as a base for the universal signals 128. As shown in the example 300A of FIG. 3A, a version of the signals 122A (here version A) is used as a baseline for the universal signals 128. Here, no encoder 124 or decoder 126 is used. Instead, the signals 122A are used as a portion of the universal signals 128 directly. Additionally, future version elements 302 are defined as the remainder of the universal signals 128. These future version elements 302 may be initially assigned to a default value, such as one or zero, or even as a random distribution of values. In such an approach, the version A portion of the universal signals 128 are readily understandable, as they are consistent with the version A signals 122A themselves.

As shown in the example 300B of FIG. 3B, a second version of signals 122B (here version B), is being used with the same defined universal signals 128. Here, a version B encoder 124B is used to encode the signals 122B into the same representation of the universal signals 128. It should be noted that the encoder 124B and decoder 126B may be trained with a loss function that ensures fidelity of the version A signals 122A as well as the version B signals 122B.

As shown in the example 300C of FIG. 3C, the first version of the signals 122A is being applied as the universal signals 128 to the decoder 126B. In this example, the signals 122A may be interworked into the version B signals 122B using the trained decoder 126B. Such an approach may useful for downstream tasks that depend on the version B signals. Significantly, in each of the examples 300A, 300B, and 300C, the same analysis models 132 may utilize the universal signals 128 for processing and generating the metrics 134.

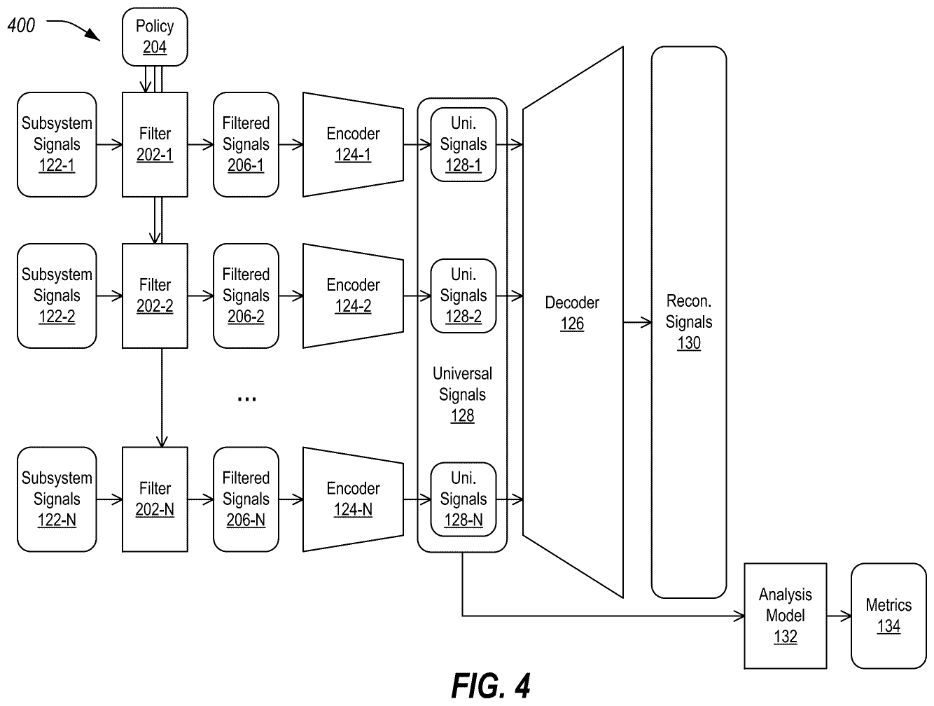

FIG. 4 illustrates an alternate autoencoder architecture 400 in which the signals 122 from separate subsystems of the vehicle 102 are processed separately. In one such example, the subsystems may refer to different sensors 106. In another example, the different subsystems may refer to different controllers 104 of the vehicle 102. In yet analysis models 132, the different subsystems may refer to different functional grouping of functionality of the vehicle 102, such as ADAS functionality, steering, engine, etc., regardless of the sensors 106 and/or controller 104 used for the functionality.

As shown, subsystem signals 122-1 through 122-N from each of the various subsystems are separately processed by filters 202-1 through 202-N into filtered signals 206-1 through 206-N, and, in turn, encoded by encoders 124-1 through 124-N into respective universal signal portions 128-1 through 128-N of the universal signals 128. These universal signal portions 128-1 through 128-N may be concatenated or otherwise combined into the overall universal signals 128. In such an approach, the complexity of the encoders 124-1 through 124-N may be reduced as compared to a single overall encoder 124, as each of the encoders 124 may operate separately. This may reduce the processing required by the vehicle 102 in producing the universal signal 128 and may also speed up the training of the autoencoder.

In such an approach, the individual encoders 124-1 through 124-N may collectively be trained with the decoder 126, as would be done for training a single monolithic encoder 124.

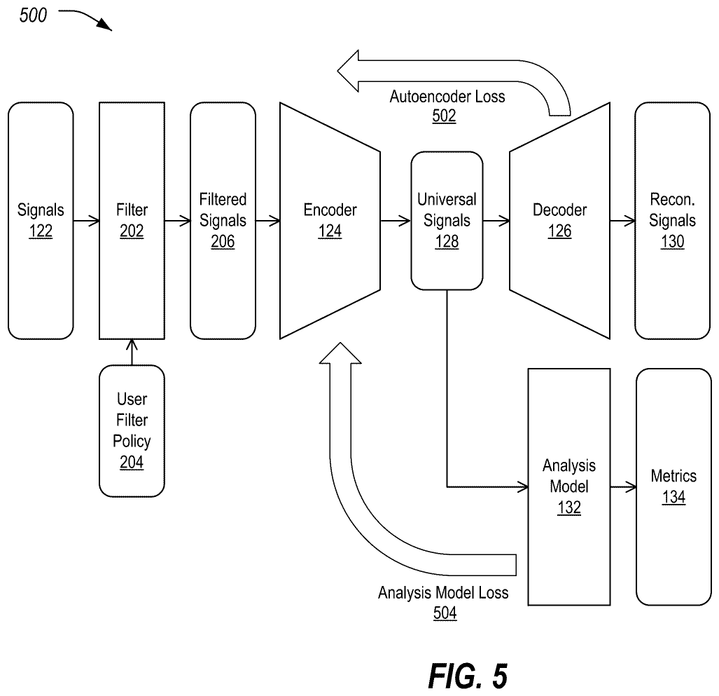

FIG. 5 illustrates an example 500 of co-training of the autoencoder with the analysis model 132. This co-training may be performed to improve the ability for preferentially capturing a useful representation of the signals 122. This co-learning approach may accordingly ensure fidelity of the universal signals 128 when converting the signal 122 input vector into the latent space representation.

The analysis model 132 may be co-trained alongside the autoencoder so that the latent space is optimized for both reconstruction and also for the downstream analysis task of the analysis model 132. The joint training process involves adding an additional loss function for the analysis model 132 task and training the entire network end-to-end.

In an example, the encoder 124 and the decoder 126 may form a Variational Autoencoder (VAE), and the combined loss function may account for both the VAE reconstruction loss and the analysis task loss. The autoencoder loss 502 may include reconstruction loss, which is a measure of how well the decoder 126 reconstructs the input (e.g., implemented as mean squared error (MSE) or binary cross-entropy loss). The autoencoder loss 502 may also include Kullback-Leibler (KL) divergence loss, which for VAEs may ensure that the latent space follows a Gaussian distribution.

The analysis loss 504 may depend on the task performed by the analysis model 132. For example, if the analysis model 132 is a classifier, then the analysis loss 504 may include classification loss, such as cross-entropy loss. If the analysis model 132 is a regression model, then the analysis loss 504 may include regression loss, such as MSE.

An example total loss function may be as follows:

$$Total Loss = α \cdot Autoencoder Loss + β \cdot Analysis Loss$$

where α and β are hyperparameters that balance the contribution of each loss term. When performing the training, the total loss may be backpropagated through the entire network, and the weights of the encoder 124, decoder 126, and analysis model 132 may be updated simultaneously. It should be noted that in some examples, to stabilize training the approach may start by training the autoencoder alone and then fine-tune the entire network after introducing the analysis model 132.

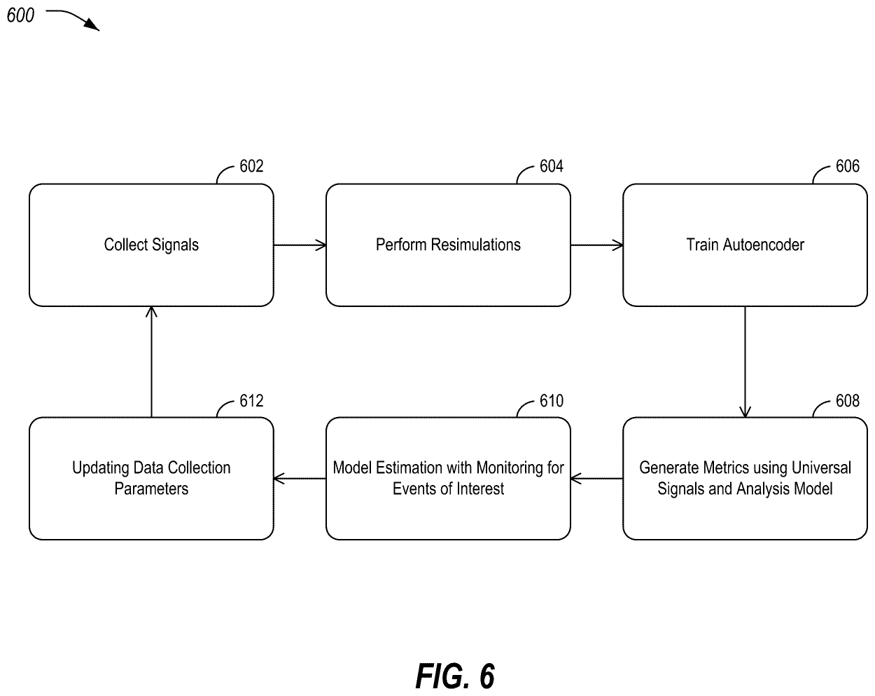

FIG. 6 illustrates an example loopwise process 600 for using the universal signals 128 for determining metrics 134 using the analysis models 132. In an example, the loopwise process 600 may be performed using the system 100, with one or more of the architectures discussed in detail herein. As shown, the process 600 is one possible application of the universal signals 128 approach for the determination of metrics 134 about the behavior of the vehicles 102.

At operation 602, signals 122 are collected from the various sensors 106 and controllers 104 of the vehicle 102, including cameras, LIDAR, radar, and other relevant inputs. This data is rich with information on the vehicle 102 environment, performance, and driver behavior, forming the foundation for the subsequent operations. As the signals 122 are gathered, the signals 122 may be normalized to ensure consistency and reliability across different sensor types and software versions, making it ready for further processing.

At operation 604, the signals 122 undergoes resimulations, where sensor inputs are replayed and/or regenerated to improve the coverage of the captured data. To use resimulation to generate training data for building the autoencoder for the vehicle signals 122, the initial dataset of signals 122 from the vehicles 102 collected at operation 602 may be used as an input. These signals 122 may include various sensor readings such as speed, acceleration, engine temperature, fuel levels, and more, collected over time under different driving conditions. The resimulation may use a model to mimic or replicate the behavior of these signals 122 under varied conditions that may not be present in the original dataset.

In an example, the existing vehicle signals 122 may be analyzed to understand their patterns, correlations, and any anomalies. A generative model, for example, may be trained on this initial dataset to learn the underlying distribution and behavior of the signals 122. Once trained, this model may resimulate the vehicle signals 122 by varying different parameters or conditions that affect the signals 122, such as changes in driving style, weather conditions, road types, or vehicle load. The generative model may then generate new instances of the signals 122, simulating how the vehicle 102 may behave under conditions that were not originally captured. The resimulated signals form an expanded dataset, representing a broader range of scenarios and variations in the performance of the vehicle 102. This expanded dataset may then be used as the training data for the autoencoder.

At operation 606, the signals 122 (e.g., as resimulated) are fed into an autoencoder model including the encoder 124 and the decoder 126. The encoder 124 is trained to compress the signals 122 into a lower-dimensional latent space that represents essential features in the universal signals 128 form, enabling efficient signal translation and representation across various software versions. The decoder 126 portion of the autoencoder is also trained to reconstruct the original signals 122, ensuring that the latent space retains the information used for accurate analysis and subsequent modeling tasks. In some examples, subsystems of the vehicle 102 are trained using separate autoencoder models, while in other examples, the collection of the signals 122 is utilized for a single autoencoder models. The training of the autoencoder may be performed independent of the training of the analysis models 132, or in a co-learning approach with the training of the analysis models 132.

At operation 608, the universal signals 128 generated by the autoencoder are utilized to produce metrics 134 by the analysis models 132. The analysis model 132 may interpret the features of the universal signals 128 to generates insights into vehicle wear, driver behavior, and/or other applications. By using the universal signals 128 instead of a specific version of signals 122, the system 100 ensures that the metrics 134 are consistent and comparable, regardless of the specific software version or sensor setup of the vehicle 102. Moreover, in doing so the analysis models 132 may not require retraining for every different version of the signals 122.

In combination with the generation of the metrics 134, the system 100 continuously monitors for events of interest, such as sudden changes in speed, sharp turns, or other outlier behaviors. In another example, the cloud server 124 may detect a change in distribution of the data being received in the signals 122 and may trigger a retraining. These events may trigger a model estimation process, where the autoencoder and/or the analysis model 132 is retrained to adjust its predictions and risk assessments based on the new data. This dynamic adjustment allows the analysis model 132 to remain responsive to changing conditions, ensuring that the generated metrics 134 accurately reflect the current state of the vehicle 102 and its operating environment.

At operation 612, the insights gained from the monitored events and model estimations feed back into updating data collection parameters of the vehicle 102. Based on the identified trends, anomalies, or areas of improvement, the system adjusts its data gathering strategies. This may include, for example, sending an updated encoder 124 to the vehicles 102 based on a retraining performed at operation 610. This updated approach enhances the next cycle of data collection, ensuring that the process continually refines itself, leading to ever more accurate and reliable analysis of the signals 122.

Variations of the process may be possible. For example, dimensionality reduction and feature engineering techniques such as manifold learning may produce varying latent dimensionality using features that are not of great interest to an engineer. In some examples, the disclosed approach may be used to provide feature engineering and dimensionality reduction in a repeatable manner.

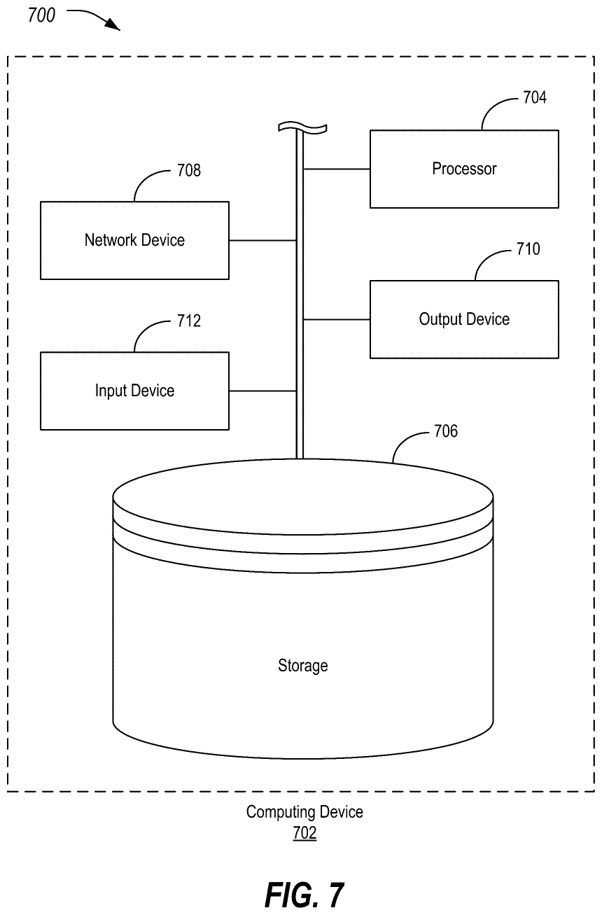

FIG. 7 illustrates an example computing device 702 for using universal signals 128 for determining vehicle metrics 134. Referring to FIG. 7, and with reference to FIGS. 1-6, the vehicle 102, controllers 104, sensors 106, TCU 110, and cloud server 124 may be examples of such computing devices 702. Computing devices 702 generally include computer-executable instructions, such as those of the vehicle data server 136 and the event processing application 138, where the instructions may be executable by one or more computing devices 702. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as signals 122, encoders 124, decoders 136, universal signals 128, reconstructed signals 130, analysis model 132, metrics 134, etc., may be stored and transmitted using a variety of computer-readable media.

As shown, the computing device 702 may include a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments may occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

1. A method of using universal signals for determining vehicle metrics, comprising:
training, based on vehicle signals received from one or more vehicles, a latent space model including an encoder and a decoder, the encoder generating universal signals as a latent representation of the vehicle signals, the decoder generating reconstructed vehicle signals from the universal signals;
sending the encoder to the one or more vehicles;
receiving universal signals from the one or more vehicles, the universal signals being generated through use of the encoder on the vehicle signals; and
applying the universal signals to an analysis model to determine metrics with respect to the operation of the one or more vehicles from the latent representation.

2. The method of claim 1, wherein the vehicle signals received from one or more vehicles are filtered according to user filter policies specifying which of the vehicle signals are to be included in the universal signals.

3. The method of claim 1, further comprising:
varying parameters and/or conditions that affect the vehicle signals, such as changes in driving style, weather conditions, road types, or vehicle load;
performing resimulating using a generative model to generate new instances of the vehicle signals, simulating vehicle behavior under the varying parameters and/or conditions; and
adding the resimulated vehicle signals to the vehicle signals as an expanded dataset for training the latent space model.

4. The method of claim 1, further comprising performing co-training of the analysis model and the latent space model using a loss function that accounts for loss in the latent space model and also loss in the analysis model, thereby ensuring fidelity of the universal signals with respect to the analysis model.

5. The method of claim 1, further comprising:
defining the universal signals as a vector of a first version of the vehicle signals in combination with additional future version elements set to a default value,
wherein the vehicle signals received from one or more vehicles are of a second version of the vehicle signals, and the training ensures fidelity of the first version of the vehicle signals and the second version of the vehicle signals through the latent space model.

6. The method of claim 1, wherein the training includes:
training a plurality of latent space models on subsets of the vehicle signals, each of the plurality of latent space models including an encoder and decoder pair; and
combining the outputs of a plurality of encoders of the encoders of the encoder and decoder pairs to generate the universal signals.

7. The method of claim 1, wherein the analysis model determines metrics with respect to vehicle maintenance.

8. The method of claim 1, wherein the analysis model determines metrics with respect to usage-based insurance.

9. The method of claim 1, further comprising:
detecting a change in distribution of the vehicle signals and/or presence of outlier events in the vehicle signals;
retraining the latent space model to generate an updated encoder; and
sending the updated encoder to the one or more vehicles.

10. A system for using universal signals for determining vehicle metrics, comprising:
one or more computing devices including non-transitory storage and a processor, configured to:
train, based on vehicle signals received from one or more vehicles, a latent space model including an encoder and a decoder, the encoder generating universal signals as a latent representation of the vehicle signals, the decoder generating reconstructed vehicle signals from the universal signals;
send the encoder to the one or more vehicles;
receive universal signals from the one or more vehicles, the universal signals being generated through use of the encoder on the vehicle signals; and
apply the universal signals to an analysis model to determine metrics with respect to the operation of the one or more vehicles from the latent representation.

11. The system of claim 10, wherein the vehicle signals received from one or more vehicles are filtered according to user filter policies specifying which of the vehicle signals are to be included in the universal signals.

12. The system of claim 10, wherein the one or more computing devices are further configured to:
vary parameters and/or conditions that affect the vehicle signals, such as changes in driving style, weather conditions, road types, or vehicle load;
perform resimulating using a generative model to generate new instances of the vehicle signals, simulating vehicle behavior under the varying parameters and/or conditions; and
add the resimulated vehicle signals to the vehicle signals as an expanded dataset for training the latent space model.

13. The system of claim 10, wherein the one or more computing devices are further configured to perform co-training of the analysis model and the latent space model using a loss function that accounts for loss in the latent space model and also loss in the analysis model, thereby ensuring fidelity of the universal signals with respect to the analysis model.

14. The system of claim 10, wherein the one or more computing devices are further configured to:
define the universal signals as a vector of a first version of the vehicle signals in combination with additional future version elements set to a default value,
wherein the vehicle signals received from one or more vehicles are of a second version of the vehicle signals, and the training ensures fidelity of the first version of the vehicle signals and the second version of the vehicle signals through the latent space model.

15. The system of claim 10, wherein the one or more computing devices are further configured to:
train a plurality of latent space models on subsets of the vehicle signals, each of the plurality of latent space models including an encoder and decoder pair; and
combine the outputs of a plurality of encoders of the encoders of the encoder and decoder pairs to generate the universal signals.

16. The system of claim 10, wherein the analysis model determines metrics with respect to vehicle maintenance.

17. The system of claim 10, wherein the analysis model determines metrics with respect to usage-based insurance.

18. A non-transitory computer-readable medium comprising instructions that, when executed by one or more processors of one or more computing devices, cause the one or more computing devices to perform operations including to:
train, based on vehicle signals received from one or more vehicles, a latent space model including an encoder and a decoder, the encoder generating universal signals as a latent representation of the vehicle signals, the decoder generating reconstructed vehicle signals from the universal signals;
send the encoder to the one or more vehicles;
receive universal signals from the one or more vehicles, the universal signals being generated through use of the encoder on the vehicle signals; and
apply the universal signals to an analysis model to determine metrics with respect to the operation of the one or more vehicles from the latent representation.

19. The non-transitory computer-readable medium of claim 18, further comprising instructions that, when executed by the one or more computing devices, cause the one or more computing devices to perform operations including to perform co-training of the analysis model and the latent space model using a loss function that accounts for loss in the latent space model and also loss in the analysis model, thereby ensuring fidelity of the universal signals with respect to the analysis model.

20. The non-transitory computer-readable medium of claim 18, further comprising instructions that, when executed by the one or more computing devices, cause the one or more computing devices to perform operations including to:
train a plurality of latent space models on subsets of the vehicle signals, each of the plurality of latent space models including an encoder and decoder pair; and
combine the outputs of a plurality of encoders of the encoders of the encoder and decoder pairs to generate the universal signals.
